(19) United States
(12) Patent Application Publication
(10) Pub. No.: US 2007/0232726 A1
(43) Pub. Date: Oct. 4, 2007

(54) ANISOTROPIC CONDUCTIVE ADHESIVE MATERIAL AND DISPLAY PANEL UNIT HAVING THE SAME

(75) Inventor: Ho-Seong Choi, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/694,300

(22) Filed: Mar. 30, 2007

(30) Foreign Application Priority Data
Mar. 31, 2006 (KR) 10-2006-0029925

(51) Int. Cl. B32B 27/18; C08K 9/12; C08K 3/08

(52) U.S. Cl. 523/210; 428/426; 428/457; 428/323; 523/216; 524/440

(57) ABSTRACT

An anisotropic conductive adhesive material and a display panel unit having the same is disclosed. The anisotropic conductive adhesive material may comprise a binder; and a conductive filler which is uniformly distributed inside the binder and is not distorted by thermal adhesion. Accordingly, the conductive filler may be uniformly distributed, thereby enhancing an electric contact quality between an electrode of a glass substrate and an FPC and reducing contact resistance.

### RELATED APPLICATION

The present disclosure relates to subject material contained in priority Korean Application No. 10-2006-0029925, filed on Mar. 31, 2006, which is herein expressly incorporated by reference in its entirety.

### BACKGROUND OF THE INVENTION

1. Field of the Invention

The present invention relates to an anisotropic conductive adhesive material and a display panel unit having the same.

2. Description of the Background Art

Generally, a conventional display panel is widely applied to various areas of a display, such as PDPs (Plasma Display Panel), LCDs (Liquid Crystal Display), OLED (Organic Light Emitting Diodes) displays.

Voltage supply to a display panel unit of the display is implemented by an FPC (Flexible Printed Circuit) which has built-in TCP (Tape Carrier Package) and COF (Chip On Flexible Printed Circuit) and the like.

The TCP (Tape Carrier Package) is one of the wireless bonding methods which assemble and mount highly-integrated semiconductor chips such as an LSI (Large Scale Integrated circuit), and can be implemented as a TAB (Tape Automated Bonding) technology which connects an IC chip to a tape film and then seals it with resin.

The COF originally was an abbreviation for ‘Chip On Flexible Printed Circuit.’ However, since the flexible PCB has been developed as a film type, it is also used as an abbreviation for ‘Chip On Film,’ and is referred to as FCOF (Flip Chip on Flexible Printed Circuit). The COF has been developed to meet a demand for a slim and simple communication device.

The FPC which has built-in the TCP and the COF connects an electrode of the FPC to an electrode of a glass substrate of the display panel in order to provide the display panel with an electric pressure by using an ACF (Anisotropic Conductive Film) or an ACP (Anisotropic Conductive Paste).

As shown in FIG. 1, when an electrode 31 of an FPC 30 and an electrode 11 of a glass substrate 10 are connected to each other by using an ACF (Anisotropic Conductive Film) 20, an air bladder may remain between the ACF 20 and the glass substrate 10. In this case, the air bladder generates moisture, thereby causing poor current flow.

Further, the ACP containing a conductive filler in a movable binder may be used to connect the electrode of the FPC and the electrode of the glass substrate each other. Herein, a generation of the air bladder may be prevented by coating the glass substrate with the ACP. In general, the ACP uses Ni particle-coated Au or a resin particle-coated Au.

FIGS. 2A and 2B show the example that an ACP 20-1 containing Ni particle-coated Au 21-1 is used. Herein, Ni particle-coated Au 21-1 has a specific gravity of approximately 8.9 [g/cm³], and the binder 22-1 has a specific gravity of approximately 2˜3 [g/cm³]. The difference in the specific gravity between Ni particle-coated Au 21-1 and the binder 22-1 causes subsidence of Ni particle-coated Au 21-1 inside the binder 22-1.

In this case, Ni particle-coated Au 21-1 is difficult to be uniformly distributed. Accordingly, when the glass substrate 10 is coated with the ACP 20-1 using a syringe, a density of Ni particle-coated Au 21-1 which is contained inside the binder 22-1 is gradually decreased, thus to be difficult to obtain an uniform contact quality between the electrode 31 of the FPC and the electrode 11 of the glass substrate 10.

FIG. 3A and FIG. 3B show an example that the ACP 20-2 containing resin particle-coated with Au 21-2 is used. Herein, resin particle-coated Au 21-2 and the binder 22-2 have almost the same specific gravity, thereby not causing subsidence of resin particle-coated Au 21-2 inside the binder 22-2. Accordingly, an uniform contact quality between the electrode 31 of the FPC and the electrode 11 of the glass substrate 10 may be obtained.

However, a shape of resin particle-coated Au 21-2 may be easily distorted by heat, thereby not fully penetrating an oxide layer 12 of the electrode 11, thus to increase a resistance value by contact.

### SUMMARY OF THE INVENTION

In view of the foregoing, the present invention, through one or more of its various aspects, embodiments, and/or specific features or sub-components, is intended to bring out one or more of the advantages noted below.

Accordingly, one object of the present invention is to uniformly distribute a conductive filler inside a binder, which is applied to an anisotropic conductive adhesive material.

Another object of the present invention is to uniformly adhere a conductive filler, which is applied to an anisotropic conductive adhesive material, to an electrode of an FPC and an electrode of a glass substrate.

Another object of the present invention is not to increase a resistance value due to contact between an electrode of an FPC and an electrode of a glass substrate by a conductive filler which is applied to an anisotropic conductive adhesive material.

To achieve these and other advantages and in accordance with the purpose of the present invention, as embodied and broadly described herein, there is provided an anisotropic conducive adhesive material and a display unit having the same.

According to one aspect of the present invention, there is provided an anisotropic conductive adhesive material, comprising: a binder; and a conductive filler which is uniformly distributed inside the binder and not distorted by thermal adhesion.

In accordance with another aspect of the present invention, there is provided an anisotropic conductive adhesive material, comprising: a binder; and a conductive filler, in which the conductive filler may include a core particle having a specific gravity similar to that of the binder and not distorted by thermal adhesion; and one or more conductive material layers disposed on an outer surface of the core particle.

In accordance with another aspect of the present invention, there is provided an anisotropic conductive adhesive material, comprising: a binder; and a conductive filler, in which the conductive filler has a core particle having a specific gravity similar to that of the binder; and one or more conductive material layers disposed on an outer surface of the core particle and not distorted by thermal adhesion.

In accordance with one aspect of the present invention, there is provided a display panel unit, comprising: an FPC (Flexible Printed Circuit); a glass substrate having an electrode; and an anisotropic conductive adhesive material, in which the anisotropic conductive adhesive material may include a binder; and a conductive filler which is uniformly distributed inside the binder and is not distorted by thermal adhesion.

In accordance with another aspect of the present invention, there is provided a display panel unit, comprising: an FPC, a glass substrate having an electrode; and an anisotropic conductive adhesive material, in which the anisotropic conductive adhesive material may include a binder; and a conductive filler, in which the conductive filler may include a core particle which has a specific gravity similar to that of the binder and is not distorted by thermal adhesion; and one or more conductive material layers disposed on an outer surface of the core particle.

In accordance with another aspect of the present invention, there is provided a display panel unit, comprising: an FPC, a glass substrate having an electrode; and an anisotropic conductive adhesive material, in which the anisotropic conductive adhesive material may include a binder; and a conductive filler, in which the conductive filler may include a core particle having a specific gravity similar to that of the binder; and one or more conductive material layers disposed on an outer surface of the core particle and not distorted by thermal adhesion.

The conductive filler may include a core particle having a density similar to that of the binder. And the conductive filler may include one or more conductive material layers disposed on an outer surface of the core particle and not distorted by thermal adhesion.

The conductive filler may include a core particle formed of ceramic. Further, the conductive filler may include a core particle which is not distorted by thermal adhesion, and one or more conductive material layers on an outer surface of the core particle.

The conductive filler may include a core particle formed of ceramic, and one or more conductive material layers disposed on an outer surface of the core particle and not distorted by thermal adhesion.

The conductive material layer may be formed as a double-layer, in which electricity conductivity of a conductive material of an outer layer is greater than that of a conductive material of an inner layer.

The anisotropic conductive adhesive material can be applied as a film or a paste.

The ceramic may be formed of one of Al₂O₃, SiC, SiN, and the like. And the conductive material layer may be formed of a Ni and/or Au layer. Herein, the conductive material layer may be formed by electroless plating.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a schematic sectional view showing that an FPC (Flexible Printed Circuit) and a display panel unit are adhered to each other by applying a conventional ACF (Anisotropic Conductive Film);

FIG. 2A is a schematic view showing the state that an ACP (Anisotropic Conductive Paste) containing a conventional Ni particle-coated Au is coated on a glass substrate by using a syringe.

FIG. 2B is a schematic sectional view showing the state that an FPC and a display panel unit are adhered to each other by applying an ACP containing the conventional Ni particle-coated Au;

FIG. 3A is a schematic view showing the state that an ACP containing a conventional resin particle-coated Au is coated on a glass substrate by using a syringe;

FIG. 3B is a schematic sectional view showing the state that an FPC and a display panel unit are adhered to each other by applying an ACP containing the conventional resin particle-coated Au;

FIGS. 4A and 4B are diagrams showing the embodiment of a conductive filler forming an anisotropic conductive adhesive material according to the present invention;

FIG. 5A is a diagram showing the state that an anisotropic conductive adhesive material is coated on a substrate as a paste according to the present invention; and

FIG. 5B is a schematic view showing the structure of a display panel unit to which an anisotropic conductive adhesive material is applied according to the present invention.

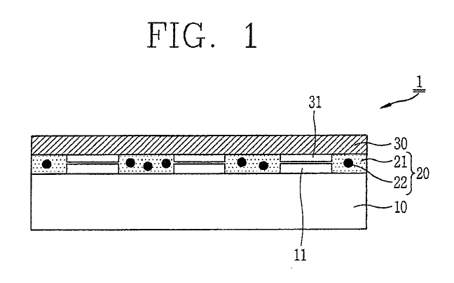

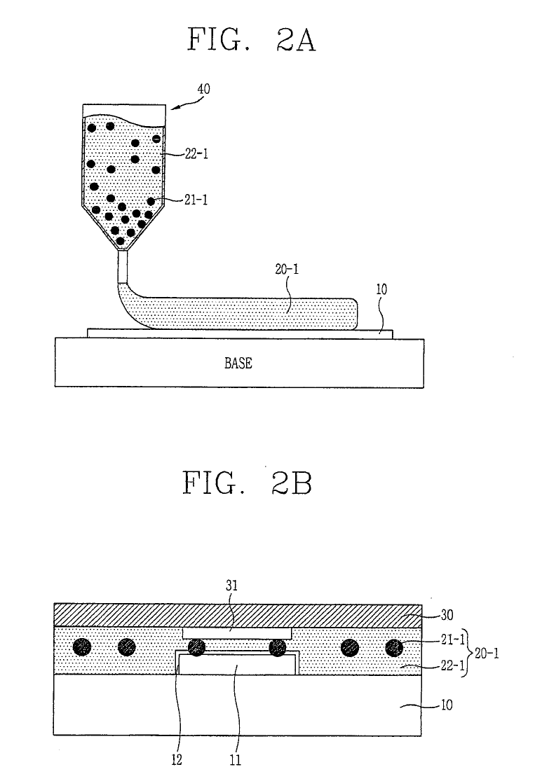

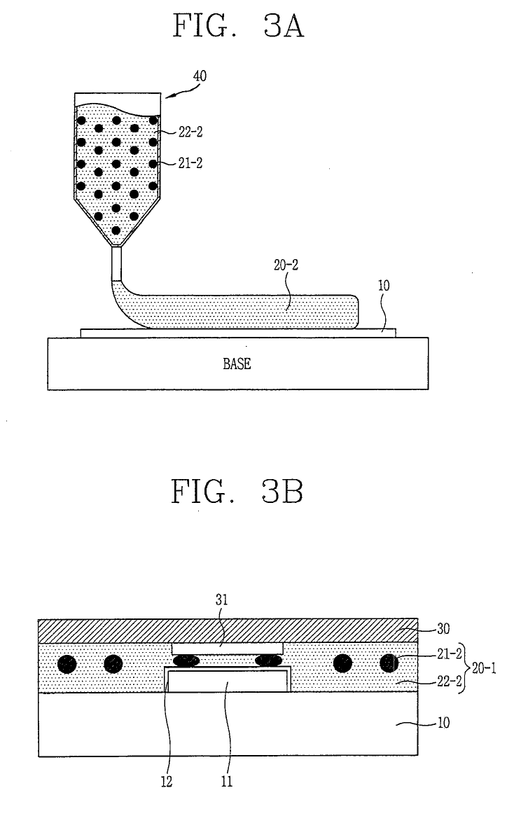

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

Reference will now be made in detail to the preferred embodiments of the present invention, examples of which are illustrated in the accompanying drawings. Wherever possible, the same reference numbers will be used throughout the drawings to refer to the same or like parts.

Hereinafter, in the preferred embodiments, an anisotropic conductive adhesive material is applied as a paste. However, the anisotropic conductive adhesive material also may be applied as a film.

Further, a display panel unit, to which an anisotropic conductive adhesive material is applied, may be applied to a panel which is used to various areas of a display such as PDPs, LCDs, OLEDs, and the like.

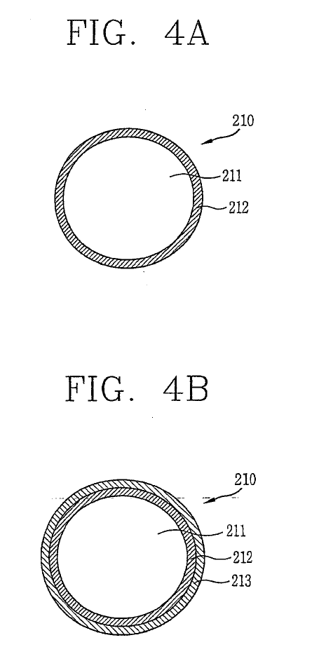

FIGS. 4A and 4B show a conductive filler 210 which is applied to an anisotropic conductive adhesive material, according to an embodiment of the present invention.

The conductive filler 210 may be uniformly distributed inside a binder 220, and is disposed between an FPC (Flexible Printed Circuit) 30 and a glass substrate 10 so that the shape of the filler 210 is not distorted by thermal adhesion. Accordingly, the conductive filler 210 can have a density same as or similar to that of the binder 220.

For such a construction, the filler 210 may include a core particle 211 and a conductive material layer 212 disposed on an outer surface of the core particle 211.

Meanwhile, the core particle 211 of the filler 210 may have a density similar to that of the binder 220 and may be formed of a material of which shape is not distorted by thermal adhesion. In this case, the conductive material layer 212 may be formed of a material having a high electricity conductivity.

Further, the core particle 211 of the filler 210 may be formed of a material having a density similar to that of the binder 220. Herein, the conductive material layer 212 may be formed of a material of which shape is not distorted by thermal adhesion. And, the conductive material layer 212 may be formed of a material having a high electricity conductivity.

As an example of this construction, the core particle 211 may be formed of a ceramic material. And, the ceramic material may be formed of one of Al₂O₃, SiC, SiN, and the like. Herein, when the density of the binder is approximately 3˜4 [g/cm³], Al₂O₃ having a density of approximately 3.97 [g/cm³], SiC having a density of approximately 3.22 [g/cm³], or SiN having a density of approximately 3.44 [g/cm³] can be used. Accordingly, the core particle 211 is not limited to the above-mentioned materials, but other appropriate materials according to the specific gravity of the binder 220 may be used.

The conductive material layers 212, 213 formed on an outer surface of the core particle 211 can be of a single layer 212 as shown in FIG. 4A, or can be of a plurality of layers 212, 213 as shown in FIG. 4B. Herein, the conductive material layer 212 having a single layer may be formed of Ni or Au. The conductive material layers 212, 213 having a plurality of layers may be formed of Ni/Au. As described above, the conductive material layers 212, 213 may be formed of a material having a high electricity conductivity. Meanwhile, the conductive material layers 212, 213 can be formed of a material of which shape is not distorted by thermal adhesion. Also, materials to be used for the conductive material layers 212, 213 can be applied onto the outer surface of the core particle 211 by using plating method, such as electroless plating method.

As shown in FIG. 4A, the conductive filler 210 may form a conductive material of a single layer on the outer surface of the core particle 211, thereby forming the conductive material layer 212. Herein, the core particle 211 may be formed of a ceramic material, and Ni, as a conductive material, can be coated on the core particle 211 serving as the conductive material layer 212 by using electroless plating method. It should be understood that the conductive material layer 212 on which the core particle 211 is coated is not limited to Ni, but as aforementioned, other conductive material including Au may be used.

Further, as shown in FIG. 4B, the conductive filler 210 may form a conductive material of a double-layer on the outer surface of the core particle 211, thereby forming the conductive material layers 212, 213.

In the similar way, the core particle 211 can be formed of a ceramic material, and Ni, as a conductive material, can be coated on the core particle 211 serving as a Ni layer by using electroless plating method, and then an Au layer can be coated thereon, thus to form conductive material layers 212, 213. Further, the Au layer can be coated on the core particle 211 first and then the Ni layer can be coated thereon, thereby forming conductive material layers 212, 213.

When the conductive material layers 212, 213 are formed as a double-layer, the conductive material of the outer layer can be formed of a material having greater electricity conductivity than that of the conductive material of the inner layer. Herein, the conductive material of the inner layer may be formed of a material of which shape is not distorted by thermal adhesion.

For example, since Au has more excellent electricity conductivity than Ni, the conductive material layers 212, 213 may be formed in an order of Ni/Au on the core particle 211, so that the conductive material layer 212 formed of Ni may maintain its shape and the conductive material layer 213 formed of Au having more excellent electricity conductivity than Ni may reduce the contact resistance.

The ceramic material used for the core particle 211 may be formed of one of Al₂O₃, SiC, SiN, and the like. Herein, the ceramic material has a density similar to that of the general binder 220. Accordingly, when the general binder is used, the core particle 211 may be formed of the ceramic material, thereby uniformly distributing inside the binder.

According to this construction, since the conductive filler 210 is uniformly distributed inside the syringe 40, when the conductive filler 210 is applied onto the glass substrate 10, it may always be uniformly distributed. Further, by using the ceramic material as the core particle 211 or by using the conductive material layer 212 having a low thermal transformation, the deformation of the conductive filler 210 by thermal adhesion may be prevented.

Accordingly, the conductive filler 210 does not be affected by the deformation due to thermal adhesion, thereby penetrating the oxide layer 12 of the electrode 11 of the glass substrate 10, thus to enhance the electric contact quality.

Meanwhile, other materials such as Cu, Zn may be used to form the conductive material layers 212, 213.

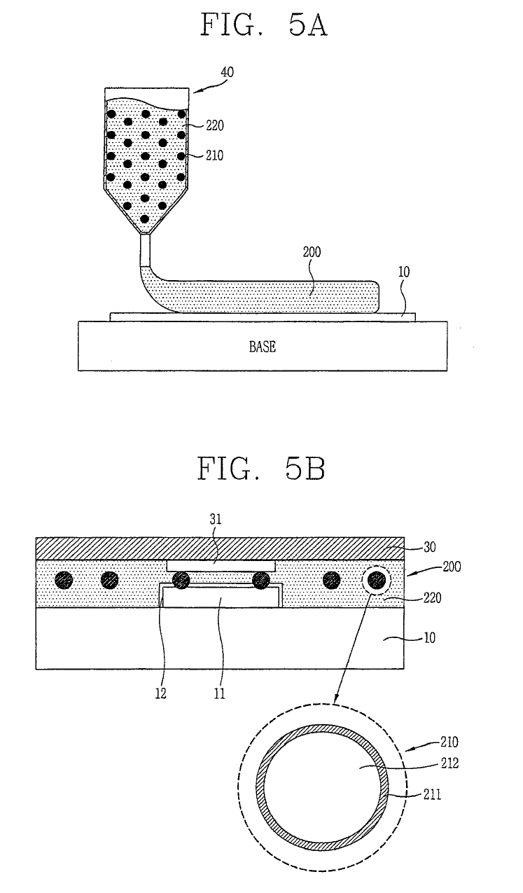

FIGS. 5A and 5B show an example that an anisotropic conductive adhesive material is applied to the display panel unit as a paste according to the present invention.

As shown, the anisotropic conductive adhesive material 200 according to the present invention is applied onto the glass substrate 10 as a paste by the syringe 40, and the FPC 30 is aligned on the anisotropic conductive adhesive material 200. Accordingly, the electrode 31 of the FPC 30 and the electrode 11 of the glass substrate 10 are adhered to each other by the anisotropic conductive adhesive material 200 so as to be electrically conductive to each other.

Referring to FIG. 5A, since the density of the conductive filler 210 and that of the binder 220 are similar, the conductive filler 210 of the anisotropic conductive adhesive material 200 disposed between the FPC 30 and the glass substrate 10 may be uniformly distributed. And, referring to FIG. 5B, the conductive filler 210 is constructed to have a sufficient hardness and a low thermal transformation, thereby penetrating the oxide layer 12 of the electrode 11 of the glass substrate 10, thus to enhance the electric contact quality.

In the detailed description, the conductive filler 210 according to the present invention, was formed of a conductive material having a single layer or a double-layer, however, the number of layers formed of the conductive material is not limited thereto.

As described above, the anisotropic conductive adhesive material and the display panel unit having the same may be embodied in several forms without departing from the spirit or essential characteristics thereof.

It should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An anisotropic conductive adhesive material, comprising:
a binder; and
a conductive filler uniformly distributed inside the binder and not distorted by thermal adhesion.

2. The anisotropic conductive adhesive material of claim 1, wherein the conductive filler may comprise a core particle having a density similar to that of the binder.

3. The anisotropic conductive adhesive material of claim 1, wherein the conductive filler may comprise one or more conductive material layers disposed on an outer surface of the core particle and not distorted by thermal adhesion.

4. The anisotropic conductive adhesive material of claim 1, wherein the conductive filler may comprise a core particle formed of ceramic.

5. The anisotropic conductive adhesive material of claim 1, wherein the conductive filler may comprise a core particle which is not distorted by thermal adhesion, and one or more conductive material layers disposed on the outer surface of the core particle.

6. The anisotropic conductive adhesive material of claim 5, wherein the conductive material layer is formed as a double-layer, in which electricity conductivity of a conductive material of an outer layer is greater than that of a conductive material of an inner layer.

7. The anisotropic conductive adhesive material of claim 1, wherein the conductive filler may comprise a core particle formed of ceramic, and one or more conductive material layers disposed on an outer surface of the core particle and are not distorted by thermal adhesion.

8. The anisotropic conductive adhesive material of claim 7, wherein the conductive material layer is formed as a double-layer, in which electricity conductivity of a conductive material of an outer layer is greater than that of a conductive material of an inner layer.

9. The anisotropic conductive adhesive material of claim 1, wherein the anisotropic conductive adhesive material may be provided as a film or a paste.

10. An anisotropic conductive adhesive material, comprising:
a binder; and
a conductive filler,
wherein the conductive filler may include a core particle which has a specific gravity similar to that of the binder and is not distorted by thermal adhesion, and one or more conductive material layers disposed on an outer surface of the core particle.

11. The anisotropic conductive adhesive material of the claim 10, wherein the core particle is formed of ceramic.

12. The anisotropic conductive adhesive material of claim 11, wherein the ceramic may be one of Al₂O₃, SiC, and SiN.

13. The anisotropic conductive adhesive material of claim 10, wherein the conductive material layer is formed as a double-layer, in which electricity conductivity of a conductive material of an outer layer is greater than that of a conductive material of an inner layer.

14. The anisotropic conductive adhesive material of claim 10, wherein the conductive material layer may be formed of a Ni and/or Au layer.

15. The anisotropic conductive adhesive material of claim 14, wherein the conductive material layer may be formed by electroless plating.

16. The anisotropic conductive adhesive material of claim 10, wherein the anisotropic conductive adhesive material may be provided as a film or a paste.

17. An anisotropic conductive adhesive material, comprising:
a binder; and
a conductive filler,
wherein the conductive filler may include a core particle having a specific gravity similar to that of the binder, and one or more conductive material layers disposed on an outer surface of the core particle and not distorted by thermal adhesion.

18. The anisotropic conductive adhesive material of claim 17, wherein the core particle may be formed of ceramic.

19. The anisotropic conductive adhesive material of claim 17, wherein the ceramic may be one of Al₂O₃, SiC, and SiN.

20. The anisotropic conductive adhesive material of claim 18, wherein the conductive material layer is formed as a double-layer, in which electricity conductivity of a conductive material of an outer layer is greater than that of a conductive material of an inner layer.

21. The anisotropic conductive adhesive material of claim 18, wherein the conductive material layer may be formed of a Ni and/or Au layer.

22. The anisotropic conductive adhesive material of claim 18, wherein the conductive material layer may be formed by electroless plating.

23. A display panel unit, comprising:
an FPC (Flexible Printed Circuit);
a glass substrate having an electrode; and
an anisotropic conductive adhesive material,
wherein the anisotropic conductive adhesive material may include a binder, and a conductive filler which is uniformly distributed inside the binder and is not distorted by thermal adhesion.

24. The display panel unit of claim 23, wherein the conductive filler may comprise a core particle having a density similar to that of the binder.

25. The display panel unit of claim 23, wherein the conductive filler may comprise one or more conductive material layers disposed on an outer surface of the core particle and not distorted by thermal adhesion.

26. The display panel unit of claim 23, wherein the conductive filler may comprise a core particle formed of ceramic.

27. The display panel unit of claim 23, wherein the conductive filler may comprise a core particle which is not distorted by thermal adhesion, and one or more conductive matte layers disposed on an outer surface of the core particle.

28. The display panel unit of claim 27, wherein the conductive material layer is formed as a double-layer, in which electricity conductivity of a conductive material of an outer layer is greater than that of a conductive material of an inner layer.

29. The display panel unit of claim 23, wherein the conductive filler may comprise a core particle formed of ceramic, and one or more conductive material layers disposed on an outer surface of the core particle and not thermally distorted.

30. The display panel unit of claim 29, wherein the conductive material layer is formed as a double-layer, in which electricity conductivity of a conductive material of an outer layer is greater than that of a conductive material of an inner layer.

31. The display panel unit of claim 23, wherein the anisotropic conductive adhesive material may be provided as a film or a paste.

32. A display panel unit, comprising:
an FPC;
a glass substrate having an electrode; and
an anisotropic conductive adhesive material,
wherein the anisotropic conductive adhesive material may include a binder, and a conductive filler, and
wherein the conductive filler may include a core particle which has a specific gravity similar to that of the binder and is not distorted by thermal adhesion, and one or more conductive material layers disposed on an outer surface of the core particle.

33. The display panel unit of claim 32, wherein the core particle may be formed of ceramic.

34. The display panel unit of claim 32, wherein the ceramic may be one of Al₂O₃, SiC, and SiN.

35. The display panel unit of claim 32, wherein the conductive material layer may be formed of a Ni and/or Au layer.

36. The display panel unit of claim 32, wherein the anisotropic conductive adhesive material may be provided as a film or a paste.

37. A display panel unit, comprising:
an FPC;
a glass substrate having an electrode; and
an anisotropic conductive adhesive material,
wherein the anisotropic conductive adhesive material may include a binder, and a conductive filler, and
wherein the conductive filler may include a core particle having a specific gravity similar to that of the binder, and one or more conductive material layers disposed on an outer surface of the core particle and not distorted by the thermal adhesion.

38. The display panel unit of claim 37, wherein the core particle may be formed of ceramic.

39. The display panel unit of claim 37, wherein the ceramic may be one of Al₂O₃, SiC, and SiN.

40. The display panel unit of claim 37, wherein the conductive material layer is formed as a double-layer, in which electricity conductivity of a conductive material of an outer layer is greater than that of a conductive material of an inner layer.

41. The display panel unit of claim 37, wherein the conductive material layer may be formed of a Ni and/or Au layer.
